(19) United States
(12) Patent Application Publication
(10) Pub. No.: US 2026/0199156 A1
(43) Pub. Date: Jul. 16, 2026

(54) DRIVABLE LIFTING AND SHIFTING CHAIR

(71) Applicant: Xiangfali Medical Technology (Fujian) Co., Ltd., Fujian (CN)

(72) Inventor: Shuifa YU, Fujian (CN)

(73) Assignee: Xiangfali Medical Technology (Fujian) Co., Ltd., Fujian (CN)

(21) Appl. No.: 19/022,708

(22) Filed: Jan. 15, 2025

(51) Int. Cl. A61G 5/04; A61G 5/10; A61G 5/12

(52) U.S. Cl. CPC A61G 5/045; A61G 5/1002; A61G 5/125

(57) ABSTRACT

Disclosed is a drivable lifting and shifting chair, including a direction adjustment assembly, where the direction adjustment assembly includes a steering handle and a control panel arranged on the steering handle, and a switch control button, and the control panel is provided with a lifting control button and/or a shifting control button. By integrating operation buttons on the control panel of the direction adjustment assembly, the drivable lifting and shifting chair allows a user with autonomous consciousness to operate care equipment by himself/herself, thereby realizing autonomous control of the drivable lifting and shifting chair, assisting in care and bringing convenience to his/her life. In addition, for the drivable lifting and shifting chair, existing gravity rollers are changed to hub motors as an improvement, thereby realizing autonomously controlled movements of care equipment, and further making the equipment intelligent and more convenient for the user to use.

### TECHNICAL FIELD

The present disclosure relates to the technical field of care equipment, and in particular to a fully automatic drivable lifting and shifting chair.

### BACKGROUND

With the coming of an aging society, an increasing number of elderly people need assisting care equipment to assist their lives. Moreover, some patients who cannot take care of themselves also need intelligent care assistance equipment. At present, there are many different types of assisting care equipment for elderly people or patients on the market, but most commercially available care assistance equipment needs to be operated by care personnel and has limited functions when used for some elderly people or patients with autonomous consciousness, greatly weakening the intelligence of the equipment.

### SUMMARY

An objective of the present disclosure is to overcome shortcomings in the prior art and provide a drivable lifting and shifting chair, so as to solve the existing technical problems of limited functions and autonomy in use for people with autonomous consciousness.

In order to realize the aforesaid objective, the present disclosure adopts the following technical solution:
an embodiment of the present disclosure provides a drivable lifting and shifting chair, including a base assembly, a lifting armrest assembly and a direction adjustment assembly, which are connected to the base assembly, and a bearing assembly controlled by a lifting movement of the lifting armrest assembly; the direction adjustment assembly includes a steering handle and a control panel arranged on the steering handle, and the control panel is provided with a switch control button, a lifting control button and/or a shifting control button.

In the embodiment, the drivable lifting and shifting chair further includes a power supply and a controller; the power supply is electrically connected to the controller, the control panel is electrically connected to the controller, and wires electrically connected to the controller and the control panel are embedded in the direction adjustment assembly.

In the embodiment, the direction adjustment assembly further includes a rotating shaft connected to the steering handle and a steering wheel connected to a lower end of the rotating shaft, and the wires are routed through the rotating shaft.

In the embodiment, the base assembly includes a base bracket and electric rollers connected to the base bracket; the electric rollers are controlled by the controller and configured to receive a control signal from the shifting control button to perform a forward or backward movement.

In the embodiment, the bearing assembly includes: a left half bearing unit and a right half bearing unit, which can be opened or closed, and a latch unit that capable of locking the left half bearing unit and the right half bearing unit when the left half bearing unit and the right half bearing unit are closed states.

In the embodiment, the left half bearing unit and the right half bearing unit have a left-right symmetrical structure, and each of them includes a bearing seat cushion, and a back cushion connected to a rear side of the bearing seat cushion; and the bearing seat cushion of the left half bearing unit and the bearing seat cushion of the right half bearing unit jointly form a through hole when closed.

In the embodiment, the lifting armrest assembly includes a U-shaped armrest and an electric lifting unit; and a top end of the electric lifting unit is connected to the U-shaped armrest and a bottom end is fixedly connected to the base assembly, and the bearing assembly is connected to the U-shaped armrest.

In the embodiment, both ends of the U-shaped armrest are hollow tubular structures, and the base assembly is further provided with guide rods that are inserted into the hollow tubular structures.

In the embodiment, the electric lifting unit is a lead screw module, an electric push rod or an electric cylinder, and the electric lifting unit is controlled by the controller and configured to receive a control signal from the lifting control button to control lifting actions of the lifting armrest assembly and the bearing assembly.

In the embodiment, the electric rollers are hub motors.

By integrating operation buttons on the control panel of the direction adjustment assembly, the drivable lifting and shifting chair in the present embodiment allows a user with autonomous consciousness to operate care equipment by himself/herself, thereby realizing autonomous control of the drivable lifting and shifting chair and bringing convenience to his/her life. In addition, for the drivable lifting and shifting chair, existing gravity rollers are changed to hub motors as an improvement, thereby realizing autonomously controlled movements of care equipment, and further making the equipment intelligent and more convenient for the user to use.

The above description is only an overview of the technical solution of the present disclosure. To understand the technical means of the present disclosure more clearly and implement it according to contents of the specification, and to make the above-mentioned and other objectives, features and advantages of the present disclosure more apparent, preferred embodiments will be hereby described below in detail.

### BRIEF DESCRIPTION OF THE DRAWINGS

FIGS. 1-3 are overall structural views from different perspectives of a drivable lifting and shifting chair according to an embodiment of the present disclosure.

FIG. 4 is a front view of a drivable lifting and shifting chair according to an embodiment of the present disclosure.

FIG. 5 is a side view of a drivable lifting and shifting chair according to an embodiment of the present disclosure.

FIG. 6 is a top view of a drivable lifting and shifting chair according to an embodiment of the present disclosure.

FIG. 7 is an enlarged structural view of part A shown in FIG. 1.

Reference numerals in the accompanying drawings:

100. drivable lifting and shifting chair; 1. base assembly; 2. lifting armrest assembly; 3. direction adjustment assembly; 4. bearing assembly; 5. pan; 11. base bracket; 12. supporting arm; 13. electric roller; 14. arched arm; 21. guide rod; 22. U-shaped armrest; 23. connecting arm; 24. lifting drive unit; 25. controller; 31. rotating shaft; 32. steering handle; 33. control panel; 34. steering wheel; 331. lifting control button; 332. shifting control button; 40. through hole; 41. left half bearing unit; 42. right half bearing unit; 43. latch; 411. bearing seat cushion; 412 back cushion; and 3134 wires.

### DETAILED DESCRIPTIONS OF THE EMBODIMENTS

To make the objectives, technical solutions and advantages of the present disclosure clearer, the present disclosure will be further described below in detail in conjunction with the drawings and specific embodiments.

The technical solutions in embodiments of the present disclosure will be described below clearly and fully in conjunction with drawings in embodiments of the present disclosure. Obviously, these embodiments described are only a part of, rather than all of, the embodiments of the present disclosure. On the basis of the embodiments of the present disclosure, all other embodiments obtained by those skilled in the art without making creative efforts should fall into the protection scope of the present disclosure.

In the description of the present disclosure, it should be understood that the orientation or location relations indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise” and “counterclockwise” are those described on the basis of drawings. As such terms are used for the purpose of facilitating and simplifying the description of the present disclosure only, rather than indicating or implying that a device or element referred to must have a specific orientation or be configured and operated in a specific orientation, they should not be understood as a limitation to the present disclosure.

In addition, terms “first” and “second” are used for the descriptive purpose only, and should not be understood as indicating or implying relative importance, or implicitly specifying quantities of technical features indicated. Thus, features defined with “first” and “second” can expressly or implicitly include one or more of these features. In the description of the present disclosure, “a plurality of” means two or more unless otherwise clearly and specifically defined.

In the present disclosure, unless otherwise clearly specified and defined, terms such as “install”, “interconnect”, “connect” and “fix” should be understood broadly. For example, they can refer to: connection, detachable connection or integration; mechanical connection or electrical connection; or direct connection, indirect connection by means of an intermediate medium, internal communication between elements or interaction between elements. Those skilled in the art can understand specific meanings of the above-mentioned terms in the present disclosure according to specific circumstances.

In the present disclosure, unless otherwise clearly specified and defined, a first feature “above” or “below” a second feature may include the first feature in direct contact with the second feature, or the first feature in indirect contact with the second feature by means of another feature between the two features. Moreover, a first feature “above”, “over” or “on” a second feature may include the first feature over or above the second feature, or only means the first feature at a higher level than the second feature. A first feature “below”, “under” or “beneath” a second feature may include the first feature under or below the second feature, or only means the first feature at a lower level than the second feature.

In the description of this specification, the description of reference terms such as “an embodiment”, “some embodiments”, “example”, “specific example” or “some examples” means that specific features, structures, materials or characteristics described in conjunction with the embodiment(s) or example(s) are included in at least one embodiment or example of the present disclosure. In this specification, illustrative expression of the above-mentioned terms should not be understood as being necessarily specific to the same embodiment or example. Moreover, the described specific features, structures, materials or characteristics may be combined in any one or more embodiments or examples in an appropriate manner.

With the coming of an aging society, an increasing number of elderly people need assisting care equipment to assist their lives. Moreover, some patients who cannot take care of themselves also need intelligent care assistance equipment. At present, there are many different types of assisting care machines for elderly people or patients on the market, but most of commercially available care assistance machines require operation by care personnel, and have limited functions and significantly reduced intelligence when used for some elderly people or patients with autonomous consciousness. On the basis of these needs, a drivable lifting and shifting chair 100 is put forward in this embodiment.

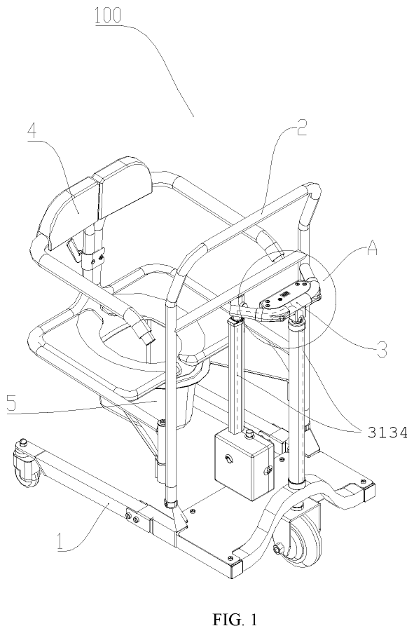

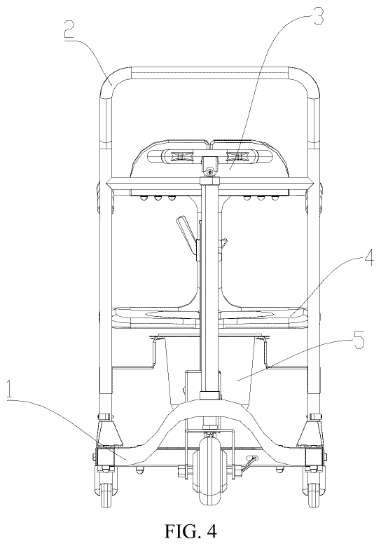

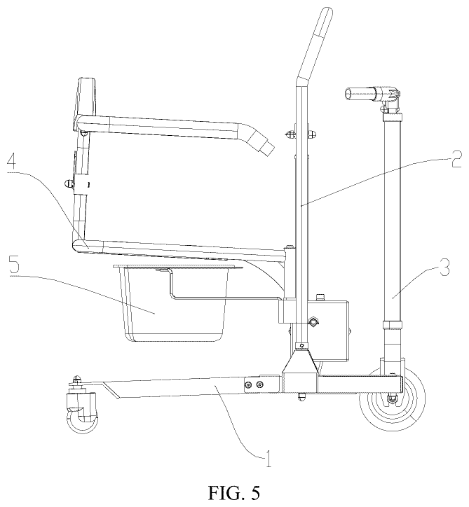

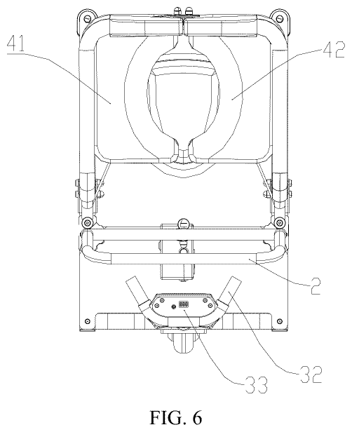

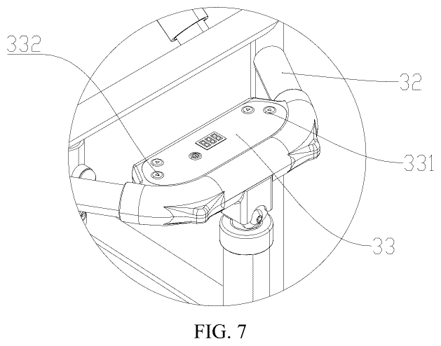

With reference to FIGS. 1-7, a drivable lifting and shifting chair 100 is provided, which is used for elderly people or patients with partial autonomous consciousness, and certainly can be used for patients or elderly people without autonomous consciousness under the condition that care personnel assist in operating drivable lifting and shifting chair 100.

In the embodiment, the drivable lifting and shifting chair 100 includes: a base assembly 1, a lifting armrest assembly 2 and a direction adjustment assembly 3 that are connected to the base assembly 1, and a bearing assembly 4. The base assembly 1 is used for driving the drivable lifting and shifting chair 100 to move as a whole, and the lifting armrest assembly 2 is used by care personnel to assist manual operations, or is held by hand by elderly people or patients in use. The bearing assembly 4 is used for a user, such as patient or elderly people, to sit or lean, and the bearing assembly 4 is connected to the lifting armrest assembly 2, such that when the user is transferred, the bearing assembly 4 can be controlled to ascend or descend by means of the lifting armrest assembly 2.

Specifically, the drivable lifting and shifting chair 100 at least includes a direction adjustment assembly 3; the direction adjustment assembly 3 includes a steering handle 32 and a control panel 33 arranged on the steering handle 32, and the control panel 33 is provided with a switch control button, lifting control button 331 and/or shifting control button 332. Of course, the control panel 33 is further provided with operation buttons corresponding to other functions of the chair, such as an emergency alarm button and a call button.

By arranging the control panel 33 on the direction adjustment assembly 3, and by integrating multi-function operation buttons on the control panel 33, the drivable lifting and shifting chair 100 in the embodiment is convenient for a user to conduct autonomous control as needed while controlling the traveling route of the chair. For example, a user in need of transfer from the drivable lifting and shifting chair 100 to a bed can first autonomously operate the shifting control button 332 to move the chair to the bedside, and then operate the lifting control button 331 to lower the bearing assembly 4 to the height of the bed surface, thereby realizing autonomous transfer. Compared with existing care machines, this chair can not only be operated with the assistance of care personnel, but also be autonomously operated according to statuses of a user, thus greatly improving convenience and intelligence in use.

Further, with reference to FIGS. 1-3 again, the drivable lifting and shifting chair 100 includes a power supply and a controller 25; the power supply is electrically connected to the controller 25, the control panel 33 is electrically connected to the controller 25, and wires electrically connected to the controller 25 and control panel 33 are embedded in the direction adjustment assembly 3. Namely, internal signal lines or power lines, etc. of the drivable lifting and shifting chair 100 are all embedded inside various components of the equipment to prevent lines from being exposed and causing unnecessary safety risks.

In the embodiment, the drivable lifting and shifting chair 100 further includes a base assembly 1; the direction adjustment assembly 3 is connected to the base assembly 1, the direction adjustment assembly 3 further includes a rotating shaft 31 connected to the steering handle 32 and a steering wheel 34 connected to a lower end portion of the rotating shaft 31, and the wires are routed through the rotating shaft 31.

Specifically, the rotating shaft 31 includes an outer tube, and a shaft lever nested in the cavity of the outer tube; a top end of the shaft lever is connected to the steering handle 32 and a lower end portion is connected to the steering wheel 34, and a lower end of the outer tube is fixedly connected to the base assembly 1. The angle of the steering wheel 34 can be adjusted by adjusting the steering handle 32, so as to change the direction of the drivable lifting and shifting chair 100 moving forward or backward.

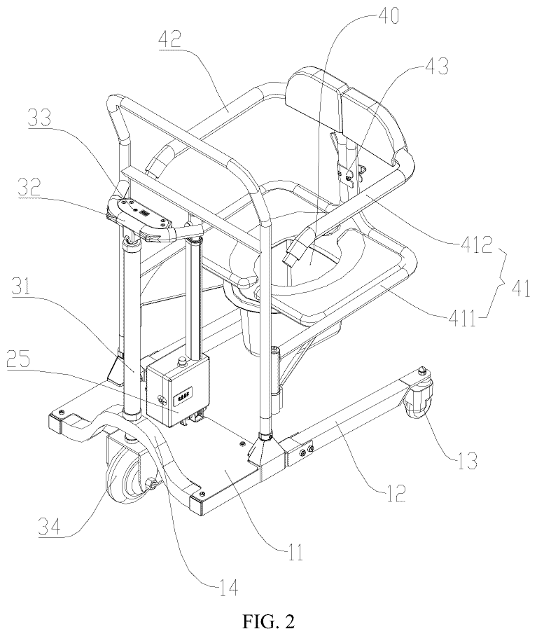

As shown in FIG. 2, the base assembly 1 includes a base bracket 11 and electric rollers 13 connected to the base bracket 11; the electric rollers 13 are controlled by the controller 25 and configured to receive a control signal from the shifting control button 332 to perform forward or backward movement.

In the embodiment, one folding supporting arm 12 is arranged on each of two edges on a rear side of the base bracket 11, the electric rollers 13 are fixedly connected to bottoms of the supporting arms 12, and the supporting arms 12 have an adjustable opening angle relative to the base bracket 11 and are hinged to the same at a connection, so as to complete folding for storage or adjust the opening angle.

In the embodiment, the electric rollers 13 are hub motors, etc., which enable electrically operated rotation and a self-locking function. Of course, in other embodiments, the electric rollers 13 may further be other drive units with electrically controlled driving and self-locking.

One arched arm 14 is arranged above a front side of the base bracket 11, and a rotating shaft 31 is connected to a middle of the arched arm 14. The supporting arms 12 are disposed by taking the position of the rotating shaft 31 as a center line of symmetry, such that the electric rollers 13 and steering wheel 34 form an isosceles triangular supporting structure.

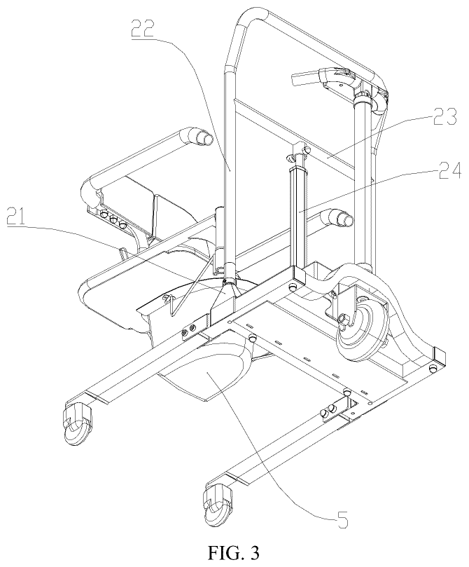

With reference to FIG. 2 and FIG. 3 again, the drivable lifting and shifting chair 100 further includes a lifting armrest assembly 2, and a bearing assembly 4 controlled by a lifting movement of the lifting armrest assembly 2.

In the embodiment, the bearing assembly 4 includes a left half bearing unit 41 and a right half bearing unit 42, which can be opened or closed, and a latch unit 43 capable of locking the left half bearing unit 41 and right half bearing unit 42 when the left half bearing unit 41 and right half bearing unit 42 are in closed states.

The left half bearing unit 41 and right half bearing unit 42 have a left-right symmetrical structure, and the left half bearing unit 41 as an embodiment includes a bearing seat cushion 411, and a back cushion 412 connected to a rear side of a bearing seat cushion 411; and the bearing seat cushion 411 of the left half bearing unit 41 and the bearing seat cushion of the right half bearing unit 42 jointly form a through hole 40 when they are closed. A pan 5 that is convenient to be taken out is further arranged below the through hole 40 and is used for urination and defecation of a user who sits in the drivable lifting and shifting chair 100.

As shown in FIG. 3, the lifting armrest assembly 2 includes a U-shaped armrest 22 and an electric lifting unit 24; a top end of the electric lifting unit 24 is connected to the U-shaped armrest 22 and a bottom end is fixedly connected to the base assembly 1, and the bearing assembly 4 is connected to the U-shaped armrest 22. When the electric lifting unit 24 is controlled to perform a lifting action, lifting of the U-shaped armrest 22 is synchronously driven, such that the bearing assembly 4 changes a vertical height with the movement of the U-shaped armrest 22 to facilitate transfer of a user.

Specifically, both ends of the U-shaped armrest 22 are hollow tubular structures, and guide rods 21 inserted into the hollow tubular structures are further arranged on the base assembly 1. The guide rods 21 are used for guiding and locating during lifting of the U-shaped armrest 22, with a function of prevention from deflection.

In the embodiment, one connecting arm 23 is transversely arranged on the U-shaped armrest 22, and a moving end of the electric lifting unit 24 is connected to a middle of the connecting arm 23.

In the embodiment, the electric lifting unit 24 is a lead screw module, an electric push rod or an electric cylinder, and the electric lifting unit 24 is controlled by the controller 25 and configured to receive a control signal from the lifting control button 331 to control lifting actions of the lifting armrest assembly 2 and bearing assembly 4.

By integrating operation buttons on the control panel 33 of the direction adjustment assembly 3, the drivable lifting and shifting chair 100 in the embodiment allows a user with autonomous consciousness to operate care equipment by himself/herself, thereby realizing autonomous control of the drivable lifting and shifting chair and bringing convenience to his/her life. In addition, for the drivable lifting and shifting chair, existing gravity rollers are changed to hub motors as an improvement, thereby realizing autonomously controlled movements of care equipment, and further making the equipment intelligent and more convenient for the user to use.

The foregoing is intended to further describe the technical contents of the present disclosure by means of embodiments to make those technical contents more accessible to readers, rather than limiting the embodiments of the present disclosure, and all technical extensions or recreations based on the present disclosure are protected by the present disclosure. The protection scope of the present disclosure should be subject to the claims.

What is claimed is:

1. A drivable lifting and shifting chair, comprising a base assembly, a lifting armrest assembly and a direction adjustment assembly that are connected to the base assembly, and a bearing assembly controlled by a lifting movement of the lifting armrest assembly, wherein the direction adjustment assembly comprises a steering handle and a control panel arranged on the steering handle, and the control panel is provided with a switch control button, a lifting control button and a shifting control button;
wherein the drivable lifting and shifting chair further comprises a power supply and a controller; the power supply is electrically connected to the controller, the control panel is electrically connected to the controller, and wires electrically connected to the controller and the control panel are embedded in the direction adjustment assembly;
wherein the direction adjustment assembly further comprises a rotating shaft connected to the steering handle and a steering wheel connected to a lower end of the rotating shaft, and the wires are routed through the rotating shaft;
wherein the base assembly comprises a base bracket and electric rollers connected to the base bracket; the electric rollers are controlled by the controller and configured to receive a control signal from the shifting control button to perform forward or backward movement;
wherein the bearing assembly comprises a left half bearing unit and a right half bearing unit, each of which can be opened or closed, and a latch unit capable of locking the left half bearing unit and the right half bearing unit when the left half bearing unit and the right half bearing unit are in closed states; and
wherein the lifting armrest assembly comprises a U-shaped armrest and an electric lifting unit; a top end of the electric lifting unit is connected to the U-shaped armrest, a bottom end of the electric lifting unit is fixedly connected to the base assembly, and the bearing assembly is connected to the U-shaped armrest.

2. (canceled)

3. (canceled)

4. (canceled)

5. (canceled)

6. The drivable lifting and shifting chair according to claim 1, wherein the left half bearing unit and the right half bearing unit have a left-right symmetrical structure, and each of the left half bearing unit and the right half bearing unit comprises a bearing seat cushion, and a back cushion connected to a rear side of the bearing seat cushion; and the bearing seat cushion of the left half bearing unit and the bearing seat cushion of the right half bearing unit jointly form a through hole when they are closed.

7. (canceled)

8. The drivable lifting and shifting chair according to claim 1, wherein both ends of the U-shaped armrest are hollow tubular structures, and the base assembly is further provided with guide rods that are inserted into the hollow tubular structures.

9. The drivable lifting and shifting chair according to claim 1, wherein the electric lifting unit is a lead screw module, an electric push rod, or an electric cylinder, and the electric lifting unit is controlled by the controller and configured to receive a control signal from the lifting control button to control lifting actions of the lifting armrest assembly and the bearing assembly.

10. The drivable lifting and shifting chair according to claim 1, wherein the electric rollers are hub motors.
